(19) United States
(12) Patent Application Publication
(10) Pub. No.: US 2012/0135218 A1
(43) Pub. Date: May 31, 2012

(54) RESIN-IMPREGNATED SHEET AND RESIN-IMPREGNATED SHEET WITH CONDUCTIVE LAYER

(75) Inventors: Changbo SHIM, Tsukuba-shi (JP); Tomoya HOSODA, Tsukuba-shi (JP); Toyonari ITO, Tsukuba-shi (JP)

(73) Assignee: SUMITOMO CHEMICAL COMPANY, LIMITED, Tokyo (JP)

(21) Appl. No.: 13/307,808

(22) Filed: Nov. 30, 2011

(30) Foreign Application Priority Data
Nov. 30, 2010 (JP) 2010-266210

(51) Int. Cl. B32B 27/04

(52) U.S. Cl. 428/297.4

(57) ABSTRACT

A resin-impregnated sheet is provided in which a dielectric loss tangent is small. In a preferred embodiment the sheet is prepared by impregnating a fiber sheet with a liquid crystal polyester which has a repeating unit represented by formula (1), a repeating unit represented by formula (2), and a repeating unit represented by formula (3), in which a content of a repeating unit comprising a 2,6-naphthylene group is 40 mole % or more based on a total amount of all repeating units, as follows:

(1)-O—Ar¹—CO—; (2)-CO—Ar²—CO—; and (3)-O—Ar³—O—

wherein Ar¹ represents a 2,6-naphthylene group, a 1,4-phenylene group, or a 4,4′-biphenylylene group; Ar² and Ar³ each independently represent a 2,6-naphthylene group, a 1,4-phenylene group, a 1,3-phenylene group, or a 4,4′-biphenylylene group; and hydrogen atoms present in the group represented by Ar¹, Ar², or Ar³ may each independently be replaced by a halogen atom, an alkyl group, or an aryl group.

### BACKGROUND OF THE INVENTION

1. Field of the Invention

The present invention relates to a resin-impregnated sheet prepared by a fiber sheet being impregnated with a liquid crystal polyester, and a resin-impregnated sheet with a conductive layer, prepared by using the same.

2. Related Background Art

As a resin-impregnated sheet used for the insulating layer of a printed wiring board, those prepared by impregnating a fiber sheet with a liquid crystal polyester are studied because heat resistance is high and a dielectric loss tangent is small. For example, obtaining a resin-impregnated sheet by impregnating a fiber sheet with a liquid composition comprising a liquid crystal polyester and a halogen-substituted phenol solvent and then removing the solvent is proposed in Japanese Patent Application Laid-Open Publication No. 2004-244621 and Japanese Patent Application Laid-Open Publication No. 2005-194406. Specifically, using one having 60 mole % of a repeating unit derived from p-hydroxybenzoic acid, 20 mole % of a repeating unit derived from 4,4′-dihydroxybiphenyl, and 20 mole % of a repeating unit derived from isophthalic acid (Japanese Patent Application Laid-Open Publication No. 2004-244621), and one having 50 mole % of a repeating unit derived from 6-hydroxy-2-naphthoic acid, 25 mole % of a repeating unit derived from 4,4′-dihydroxybiphenyl, and 25 mole % of a repeating unit derived from isophthalic acid (Japanese Patent Application Laid-Open Publication No. 2005-194406), as the liquid crystal polyester, is disclosed.

In addition, obtaining a resin-impregnated sheet by impregnating a fiber sheet with a liquid composition comprising a liquid crystal polyester having a repeating unit derived from an aromatic diamine and/or a repeating unit derived from an aromatic hydroxyamine, and an aprotic solvent, and then removing the solvent is proposed in Japanese Patent Application Laid-Open Publication No. 2006-1959 and Japanese Patent Application Laid-Open Publication No. 2007-146139. Specifically, one having 50 mole % of a repeating unit derived from 6-hydroxy-2-naphthoic acid, 25 mole % of a repeating unit derived from isophthalic acid, and 25 mole % of a repeating unit derived from p-aminophenol (Japanese Patent Application Laid-Open Publication No. 2006-1959), one having 35 mole % of a repeating unit derived from p-hydroxybenzoic acid, 5 mole % of a repeating unit derived from 6-hydroxy-2-naphthoic acid, 30 mole % of a repeating unit derived from isophthalic acid, and 30 mole % of a repeating unit derived from p-aminophenol (Japanese Patent Application Laid-Open Publication No. 2007-146139), and one having 35 mole % of a repeating unit derived from 6-hydroxy-2-naphthoic acid, 32.5 mole % of a repeating unit derived from isophthalic acid, and 32.5 mole % of a repeating unit derived from p-aminophenol (Japanese Patent Application Laid-Open Publication No. 2007-146139), as the liquid crystal polyester, are disclosed.

### SUMMARY OF THE INVENTION

It is an object of the present invention to provide a resin-impregnated sheet in which a dielectric loss tangent is smaller.

In order to achieve the above object, the present invention provides a resin-impregnated sheet prepared by a fiber sheet being impregnated with a liquid crystal polyester which has a repeating unit represented by formula (1), a repeating unit represented by formula (2), and a repeating unit represented by formula (3) and in which a content of a repeating unit comprising a 2,6-naphthylene group is 40 mole % or more with respect to a total amount of all repeating units.

—O—Ar¹—CO— (1)

—CO—Ar²—CO— (2)

—O—Ar³—O— (3)

wherein Ar¹ represents a 2,6-naphthylene group, a 1,4-phenylene group, or a 4,4′-biphenylylene group; Ar² and Ar³ each independently represent a 2,6-naphthylene group, a 1,4-phenylene group, a 1,3-phenylene group, or a 4,4′-biphenylylene group; and hydrogen atoms present in the group represented by Ar¹, Ar², or Ar³ may each independently be replaced by a halogen atom, an alkyl group, or an aryl group.

In the resin-impregnated sheet of the present invention, a dielectric loss tangent is small, and by using this, it is possible to obtain a resin-impregnated sheet with a conductive layer in which a dielectric loss tangent is small.

### BRIEF DESCRIPTION OF THE DRAWING

FIG. 1 is a diagram schematically showing a cross-sectional configuration of a resin-impregnated sheet with a conductive layer in a preferred embodiment.

### DESCRIPTION OF THE PREFERRED EMBODIMENTS

In a resin-impregnated sheet in a preferred embodiment of the present invention, a liquid crystal polyester with which a fiber sheet is impregnated is a polyester that exhibits optical anisotropy during melting, and has a repeating unit represented by formula (1) (hereinafter sometimes referred to as a repeating unit (1)), a repeating unit represented by formula (2) (hereinafter sometimes referred to as a repeating unit (2)), and a repeating unit represented by formula (3) (hereinafter sometimes referred to as a repeating unit (3)).

—O—Ar¹—CO— (1)

—CO—Ar²—CO— (2)

—O—Ar³—O— (3)

wherein Ar¹ represents a 2,6-naphthylene group, a 1,4-phenylene group, or a 4,4′-biphenylylene group; Ar² and Ar³ each independently represent a 2,6-naphthylene group, a 1,4-phenylene group, a 1,3-phenylene group, or a 4,4′-biphenylylene group; and hydrogen atoms present in the group represented by Ar¹, Ar², or Ar³ may each independently be replaced by a halogen atom, an alkyl group having 1 to 10 carbon atoms, or an aryl group having 6 to 20 carbon atoms.

Examples of the above halogen atom include a fluorine atom, a chlorine atom, a bromine atom, and an iodine atom. Examples of the above alkyl group include a methyl group, an ethyl group, a n-propyl group, an isopropyl group, a n-butyl group, an isobutyl group, a sec-butyl group, a tert-butyl group, a n-hexyl group, a 2-ethylhexyl group, a n-octyl group, and a n-decyl group, and they generally have 1 to 10 carbon atoms. Examples of the above aryl group include a phenyl group, an o-tolyl group, a m-tolyl group, a p-tolyl group, a 1-naphthyl group, and a 2-naphthyl group, and they generally have 6 to 20 carbon atoms. When the above hydrogen atoms are replaced by these groups, the number of them is generally two or less, preferably one or less, for each of the above group represented by Ar¹, Ar², or Ar³, each independently.

The repeating unit (1) is a repeating unit derived from a predetermined aromatic hydroxycarboxylic acid. As the repeating unit (1), one in which Ar¹ is a 2,6-naphthylene group, that is, a repeating unit derived from 6-hydroxy-2-naphthoic acid, is preferred.

The repeating unit (2) is a repeating unit derived from a predetermined aromatic dicarboxylic acid. As the repeating unit (2), one in which Ar² is a 2,6-naphthylene group, that is, a repeating unit derived from 2,6-naphthalenedicarboxylic acid, and one in which Ar² is a 1,4-phenylene group, that is, a repeating unit derived from terephthalic acid, are preferred.

The repeating unit (3) is a repeating unit derived from a predetermined aromatic diol. As the repeating unit (3), one in which Ar³ is a 1,4-phenylene group, that is, a repeating unit derived from hydroquinone, and one in which Ar³ is a 4,4′-biphenylylene group, that is, a repeating unit derived from 4,4′-dihydroxybiphenyl, are preferred.

In the liquid crystal polyester, the content of repeating units comprising a 2,6-naphthylene group, that is, the total content of the repeating unit (1) in which Ar¹ is a 2,6-naphthylene group, the repeating unit (2) in which Ar² is a 2,6-naphthylene group, and the repeating unit (3) in which Ar³ is a 2,6-naphthylene group, is 40 mole % or more with respect to the total amount of all repeating units (a value obtained by obtaining an amount corresponding to the amount of substance (mole) for each repeating unit by dividing the mass of each repeating unit constituting the liquid crystal polyester by the formula weight of each repeating unit, and summing the amounts). By impregnating the fiber sheet with the liquid crystal polyester having such a predetermined repeating unit composition, it is possible to obtain a resin-impregnated sheet in which a dielectric loss tangent is small. The content of this 2,6-naphthylene group is preferably 50 mole % or more, more preferably 60 mole % or more, and further preferably 70 mole % or more.

In addition, in the liquid crystal polyester, the content of the repeating unit (1) is preferably 30 to 80 mole %, more preferably 40 to 70 mole %, and further preferably 45 to 65 mole %, with respect to the total amount of all repeating units. The content of the repeating unit (2) is preferably 10 to 35 mole %, more preferably 15 to 30 mole %, and further preferably 17.5 to 27.5 mole %, with respect to the total amount of all repeating units. The content of the repeating unit (3) is preferably 10 to 35 mole %, more preferably 15 to 30 mole %, and further preferably 17.5 to 27.5 mole %, with respect to the total amount of all repeating units. The liquid crystal polyester having such a predetermined repeating unit composition is excellent in the balance of heat resistance and moldability. It is preferred that the content of the repeating unit (2) and the content of the repeating unit (3) are substantially equal. In addition, the liquid crystal polyester may have a repeating unit other than the repeating units (1) to (3), as required, and its content is generally 10 mole % or less, preferably 5 mole % or less, with respect to the total amount of all repeating units.

A typical example of a liquid crystal polyester in which heat resistance and melt tension are high is one which has preferably 40 to 74.8 mole %, more preferably 40 to 64.5 mole %, and further preferably 50 to 58 mole % of the repeating unit (1) in which Ar¹ is a 2,6-naphthylene group, that is, a repeating unit derived from 6-hydroxy-2-naphthoic acid, has preferably 12.5 to 30 mole %, more preferably 17.5 to 30 mole %, and further preferably 20 to 25 mole % of the repeating unit (2) in which Ar² is a 2,6-naphthylene group, that is, a repeating unit derived from 2,6-naphthalenedicarboxylic acid, has preferably 0.2 to 15 mole %, more preferably 0.5 to 12 mole %, and further preferably 2 to 10 mole % of the repeating unit (2) in which Ar² is a 1,4-phenylene group, that is, a repeating unit derived from terephthalic acid, and has preferably 12.5 to 30 mole %, more preferably 17.5 to 30 mole %, and further preferably 20 to 25 mole % of the repeating unit (3) in which Ar³ is a 1,4-phenylene group, that is, a repeating unit derived from hydroquinone, with respect to the total amount of all repeating units, and in which the content of the repeating unit (2) in which Ar² is a 2,6-naphthylene group is preferably 0.5 mole times or more, more preferably 0.6 mole times or more, the total content of the repeating unit (2) in which Ar² is a 2,6-naphthylene group and the repeating unit (2) in which Ar² is a 1,4-phenylene group.

The liquid crystal polyester can be produced by polymerizing (polycondensing) a monomer providing the repeating unit (1), that is, a predetermined aromatic hydroxycarboxylic acid, a monomer providing the repeating unit (2), that is, a predetermined aromatic dicarboxylic acid, and a monomer providing the repeating unit (3), that is, a predetermined aromatic diol, so that the total amount of monomers having a 2,6-naphthylene group, that is, the total amount of 6-hydroxy-2-naphthoic acid, 2,6-naphthalenedicarboxylic acid, and 2,6-naphthalenediol, is 40 mole % or more with respect to the total amount of all monomers. At the time, the aromatic hydroxycarboxylic acid, the aromatic dicarboxylic acid, and the aromatic diol may each independently be replaced by a polymerizable derivative thereof, for part or all thereof. Examples of polymerizable derivatives of compounds having a carboxyl group, such as an aromatic hydroxycarboxylic acid and an aromatic dicarboxylic acid, include one prepared by converting a carboxyl group into an alkoxycarbonyl group or an aryloxycarbonyl group, one prepared by converting a carboxyl group into a haloformyl group, and one prepared by converting a carboxyl group into an acyloxycarbonyl group. Examples of polymerizable derivatives of compounds having a hydroxyl group, such as an aromatic hydroxycarboxylic acid and an aromatic diol, include one prepared by acylating a hydroxyl group to convert it into an acyloxyl group.

In addition, it is preferred that the liquid crystal polyester is produced by melt polymerizing the monomers and solid phase polymerizing an obtained polymer (prepolymer). Thus, it is possible to produce a liquid crystal polyester in which heat resistance and melt tension are high, with good operability. The melt polymerization may be performed in the presence of a catalyst. Examples of this catalyst include metal compounds, such as magnesium acetate, stannous acetate, tetrabutyl titanate, lead acetate, sodium acetate, potassium acetate, and antimony trioxide, and nitrogen-containing heterocyclic compounds, such as N,N-dimethylaminopyridine and N-methylimidazole, and nitrogen-containing heterocyclic compounds are preferably used.

In the liquid crystal polyester, its flow start temperature is preferably 280° C. or more, more preferably 290° C. or more, and further preferably 295° C. or more, and is generally 380° C. or less, preferably 350° C. or less. As flow start temperature becomes higher, heat resistance and melt tension improve easily, but if the flow start temperature is too high, high temperature is required for melting, and the liquid crystal polyester tends to thermally degrade easily during molding.

The flow start temperature is also referred to as flow temperature, and is a temperature at which melt viscosity is 4800 Pa·s (48,000 poises) when, using a capillary rheometer having a nozzle having an inner diameter of 1 mm and a length of 10 mm, a heated and melted liquid crystal polyester is extruded from the nozzle under a load of 9.8 MPa (100 kg/cm²) at temperature increase rate of 4° C./min, and the flow start temperature is a standard of the molecular weight of the liquid crystal polyester (see “Liquid Crystal Polymers-Synthesis·Molding·Application-,” edited by Naoyuki Koide, CMC Publishing Co., Ltd., June 5, 1987, p. 95).

Other components may be mixed into the liquid crystal polyester, as required, to provide a composition. Examples of the other components include fillers, thermoplastic resins other than liquid crystal polyesters, and additives. The proportion of the liquid crystal polyester in the entire composition is preferably 80% by mass or more, more preferably 90% by mass or more.

Examples of the fillers include glass fibers, such as milled glass fibers and chopped glass fibers, metallic or nonmetallic whiskers, such as potassium titanate whiskers, alumina whiskers, aluminum borate whiskers, silicon carbide whiskers, and silicon nitride whiskers, glass beads, hollow glass spheres, glass powders, mica, talc, clay, silica, alumina, potassium titanate, wollastonite, calcium carbonate (heavy, light, colloidal, and the like), magnesium carbonate, basic magnesium carbonate, sodium sulfate, calcium sulfate, barium sulfate, calcium sulfite, aluminum hydroxide, magnesium hydroxide, calcium hydroxide, calcium silicate, silica sand, silica stone, quartz, titanium oxide, zinc oxide, iron oxide, graphite, molybdenum, asbestos, silica alumina fibers, alumina fibers, gypsum fibers, carbon fibers, carbon black, white carbon, diatomaceous earth, bentonite, sericite, shirasu, and graphite, and it is also possible to use two or more thereof, as required. Among them, glass fibers, mica, talc, and carbon fibers are preferably used.

The fillers may be those surface-treated as required. Examples of this surface treatment agent include reactive coupling agents, such as silane-based coupling agents, titanate-based coupling agents, and borane-based coupling agents, and lubricants, such as higher fatty acids, higher fatty acid esters, higher fatty acid metal salts, and fluorocarbon-based surfactants.

Examples of the thermoplastic resins other than liquid crystal polyesters include polycarbonate, polyamide, polysulfone, polyphenylene sulfide, polyphenylene ether, polyetherketone, and polyetherimide resins.

Examples of the additives include release improving agents, such as fluororesins and metallic soaps, nucleating agents, antioxidants, stabilizers, plasticizers, slip agents, coloration preventing agents, coloring agents, ultraviolet absorbing agents, antistatic agents, lubricants, and flame retardants.

By impregnating the fiber sheet with the thus obtained liquid crystal polyester or composition thereof, it is possible to obtain a resin-impregnated sheet in which a dielectric loss tangent is small.

Examples of fibers constituting the fiber sheet include inorganic fibers, such as glass fibers, carbon fibers, and ceramic fibers; and organic fibers, such as liquid crystal polyester fibers, other polyester fibers, aramid fibers, and polybenzazole fibers, and two or more thereof may be used. Among them, glass fibers are preferred. Examples of the glass fibers include alkali-containing glass fibers, alkali-free glass fibers, and low dielectric glass fibers.

The fiber sheet may be a woven fabric (woven cloth), may be a knitted fabric, or may be a nonwoven cloth, but it is preferred that the fiber sheet is a woven fabric because the dimensional stability of the resin-impregnated sheet improves easily. Examples of the weave of a woven fabric include a plain weave, a sateen weave, a twill weave, and a basket weave. The weave density of the woven fabric is generally 10 to 100/25 mm.

The thickness of the fiber sheet is generally 10 to 200 μm, preferably 10 to 180 μm. The mass per unit area of the fiber sheet is generally 10 to 300 g/m². It is preferred that the fiber sheet is surface-treated with a coupling agent, such as a silane coupling agent, so that adhesiveness to the resin improves.

The impregnation of the fiber sheet with the liquid crystal polyester is preferably performed by melt impregnation, and more preferably performed by pressing liquid crystal polyester sheets, which are sheets of the liquid crystal polyester or a composition thereof, and the fiber sheet.

Examples of a method for the sheeting of the liquid crystal polyester include extrusion methods, press molding methods, solution casting methods, and injection molding methods, and extrusion methods are preferred. Examples of the extrusion methods include T-die methods and inflation methods, and in T-die methods, uniaxial stretching may be performed, or biaxial stretching may be performed.

The stretch ratio (draft ratio) of a uniaxially stretched sheet is generally 1.1 to 40, preferably 10 to 40, and more preferably 15 to 35. The stretch ratio of a biaxially stretched sheet in an MD direction (extrusion direction) is generally 1.2 to 40, and the stretch ratio of the biaxially stretched sheet in a TD direction (direction perpendicular to the extrusion direction) is generally 1.2 to 20. The stretch ratio (drawdown ratio=bubble take-off rate/resin discharge rate) of an inflated sheet in an MD direction is generally 1.5 to 50, preferably 5 to 30, and the stretch ratio (blow-up ratio=bubble diameter/annular slit diameter) of the inflated sheet in a TD is generally 1.5 to 10, preferably 2 to 5.

The thickness of the liquid crystal polyester sheet is preferably 5 to 100 μm, more preferably 10 to 75 μm, and further preferably 15 to 75 μm. If the liquid crystal polyester sheet is too thin, the strength tends to be insufficient, and if the liquid crystal polyester sheet is too thick, the flexibility tends to be insufficient.

It is preferred that the pressing of the liquid crystal polyester sheets and the fiber sheet is performed by disposing the liquid crystal polyester sheets on both sides of the fiber sheet and hot pressing them by a press. At the time, a plurality of the fiber sheets may be laid on each other. In addition, a plurality of the liquid crystal polyester sheets may be disposed on both sides of the fiber sheet, each independently. In addition, a plurality of sets each prepared by disposing the liquid crystal polyester sheets on both sides of the fiber sheet may be laid on each other.

The temperature of the pressing is generally 300 to 360° C., preferably 320 to 340° C. The pressure of the pressing is generally 1 to 20 MPa, preferably 3 to 10 MPa. The time of the pressing is generally 5 to 60 minutes, preferably 10 to 50 minutes. It is preferred that the pressing is performed under reduced pressure by setting pressure in the press to a reduced pressure of preferably 5 kPa or less.

By laminating a plurality of the thus obtained resin-impregnated sheets, as required, and then forming a conductor layer on at least one surface thereof, it is possible to obtain a resin-impregnated sheet with a conductive layer.

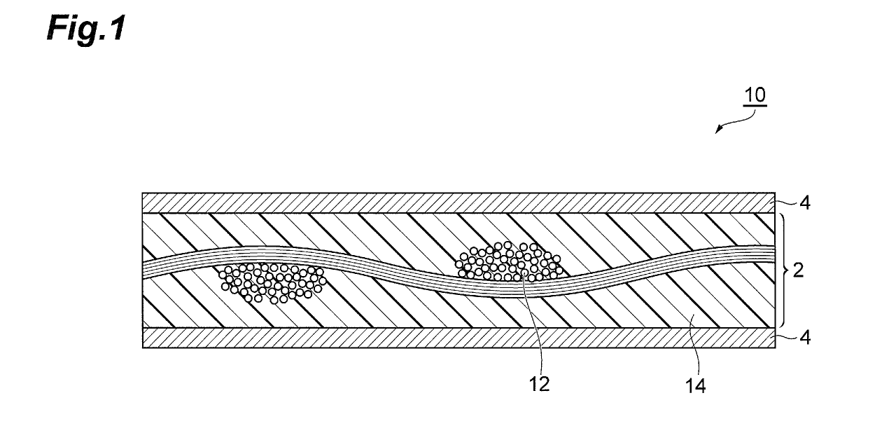

FIG. 1 is a diagram schematically showing a cross-sectional configuration of a resin-impregnated sheet with a conductive layer in a preferred embodiment. As shown in FIG. 1, a resin-impregnated sheet with a conductive layer 10 has a structure in which a conductive layer 4 is laminated on both surface of a resin-impregnated sheet 2. The resin-impregnated sheet 2 is composed of a fiber sheet 12, and a liquid crystal polyester 14 with which the fiber sheet 12 is impregnated.

The formation of the conductive layer may be performed by laminating metal foil by adhesion with an adhesive, fusion by hot pressing, or the like, or may be performed by coating with metal particles by a plating method, a screen printing method, a sputtering method, or the like. In addition, in the above hot pressing of the liquid crystal polyester sheets and the fiber sheet, by disposing metal foil on both outer sides, it is possible to obtain a resin-impregnated sheet and at the same time obtain a resin-impregnated sheet with conductive layers. Examples of a metal constituting the metal foil or the metal particles include copper, aluminum, and silver, but in terms of conductivity and cost, copper is preferably used.

By forming a predetermined wiring pattern in the conductive layer of the thus obtained resin-impregnated sheet with a conductive layer, it is possible to obtain a printed wiring board in which the dielectric loss tangent of a resin-impregnated sheet, which is an insulating layer, is small.

### EXAMPLES

<Measurement of Flow Start Temperature>

Using a flow tester (“model CFT-500” from SHIMADZU CORPORATION), a cylinder to which a die having a nozzle having an inner diameter of 1 mm and a length of 10 mm was attached was filled with about 2 g of a liquid crystal polyester, and the liquid crystal polyester was melted and extruded from the nozzle under a load of 9.8 MPa (100 kg/cm²), while temperature was increased at a rate of 4° C./min, and a temperature at which a viscosity of 4800 Pa·s (48000 poises) was shown was measured.

<Measurement of Relative Dielectric Constant and Dielectric Loss Tangent>

The copper foil of a resin-impregnated sheet with conductive layers was removed by etching, using a ferric chloride solution (Kida Co., Ltd., 40° Baume), a 2 mm×70 mm test piece was cut from the remaining resin-impregnated sheet, and a relative dielectric constant and a dielectric loss tangent were measured at a measurement frequency of 1 GHz, using a cavity resonator (“E8363B” from Agilent Technologies).

<Measurement of Coefficient of Linear Expansion>

The copper foil of a resin-impregnated sheet with conductive layers was removed by etching, using a ferric chloride solution (Kida Co., Ltd., 40° Baume), and for the remaining resin-impregnated sheet, the coefficient of linear expansion in a plane direction at 50 to 100° C. was measured in two orthogonal directions (an X-direction and a Y-direction) according to JIS C6481 “Test methods of copper-clad laminates for printed wiring boards,” using a thermomechanical analysis (TMA) apparatus (Seiko Instruments Inc.).

<Evaluation of Solder Heat Resistance>

After a resin-impregnated sheet with conductive layers was immersed in a solder bath at 280° C. for 1 minute, a surface state was visually observed, and a case where the delamination and blistering of copper foil were not confirmed was ◯, and a case where the delamination and/or blistering of copper foil was confirmed was ×.

### Example 1

### <Production of Liquid Crystal Polyester>

1034.99 g (5.5 moles) of 6-hydroxy-2-naphthoic acid, 378.33 g (1.75 moles) of 2,6-naphthalenedicarboxylic acid, 83.07 g (0.5 moles) of terephthalic acid, 272.52 g (2.475 moles: an excess of 0.225 moles with respect to the total amount of 2,6-naphthalenedicarboxylic acid and terephthalic acid) of hydroquinone, 1226.87 g (12 moles) of acetic anhydride, and 0.17 g of 1-methylimidazole as a catalyst were placed in a reactor equipped with a stirring apparatus, a torquemeter, a nitrogen gas introducing tube, a thermometer, and a reflux condenser, a gas in the reactor was replaced by a nitrogen gas, and then, under a nitrogen gas flow, with stirring, temperature was increased from room temperature to 145° C. over 15 minutes, and the mixture was refluxed at 145° C. for 1 hour. Then, while by-product acetic acid and unreacted acetic anhydride were distilled off, temperature was increased from 145° C. to 310° C. over 3 hours and 30 minutes and maintained at 310° C. for 3 hours, and then, contents were removed and cooled to room temperature. Solid phase polymerization was performed by grinding an obtained solid to a particle diameter of about 0.1 to 1 mm by a grinder, and, under a nitrogen gas atmosphere, increasing temperature from room temperature to 250° C. over 1 hour, increasing temperature from 250° C. to 310° C. over 10 hours, and maintaining temperature at 310° C. for 5 hours. After the solid phase polymerization, a product was cooled to obtain a powdery liquid crystal polyester. This liquid crystal polyester had 55 mole % of the repeating unit (1) in which Ar¹ was a 2,6-naphthylene group, 17.5 mole % of the repeating unit (2) in which Ar² was a 2,6-naphthylene group, 5 mole % of the repeating unit (2) in which Ar² was a 1,4-phenylene group, and 22.5 mole % of the repeating unit (3) in which Ar³ was a 1,4-phenylene group, with respect to the total amount of all repeating units, and its flow start temperature was 333° C.

<Fabrication of Liquid Crystal Polyester Sheet>

The liquid crystal polyester was granulated and formed into a pellet shape by a twin screw extruder (“PCM-30” from Ikegai Corp), then fed to a single screw extruder (screw diameter: 50 mm), melted, extruded into a sheet shape from a T-die (lip length: 300 mm, lip clearance: 1 mm, die temperature: 350° C.), and cooled to obtain a liquid crystal polyester sheet having a thickness of 20 μm.

<Production of Resin-Impregnated Sheet with Conductive Layers>

A glass cloth (Arisawa Mfg. Co., Ltd., thickness: 96 μm, IPC name: 2116) was used as a fiber sheet, two liquid crystal polyester sheets and copper foil (“3EC-VLP” from Mitsui Mining & Smelting Co., Ltd., 18 μm) were disposed in this order on both sides of the glass cloth, and they were pressed at 5 MPa at 330° C. for 30 minutes, using a high-temperature vacuum press (“VH1-1765” from KITAGAWA SEIKI CO., LTD), to obtain a resin-impregnated sheet with conductive layers. The thickness of a resin-impregnated sheet layer in this resin-impregnated sheet with conductive layers was 105 μm on average, and variations in thickness were 3%. For this resin-impregnated sheet with conductive layers, a relative dielectric constant, a dielectric loss tangent, and the coefficient of linear expansion were measured, and solder heat resistance was evaluated. Results are shown in Table 1.

### Example 2

An operation similar to that of Example 1 was performed, except that a glass cloth (Arisawa Mfg. Co., Ltd., thickness: 45 μm, IPC name: 1078) was used as a fiber sheet, and one liquid crystal polyester sheet was disposed on both sides of the glass, to obtain a resin-impregnated sheet with conductive layers. The thickness of a resin-impregnated sheet layer in this resin-impregnated sheet with conductive layers was 56 μm on average, and variations in thickness were 3%. For this resin-impregnated sheet with conductive layers, a relative dielectric constant, a dielectric loss tangent, and the coefficient of linear expansion were measured, and solder heat resistance was evaluated. Results are shown in Table 1.

### Comparative Example 1

### <Production of Liquid Crystal Polyester>

1976 g (10.5 moles) of 6-hydroxy-2-naphthoic acid, 1474 g (9.75 moles) of 4-hydroxyacetanilide, 1620 g (9.75 moles) of isophthalic acid, and 2374 g (23.25 moles) of acetic anhydride were placed in a reactor equipped with a stirring apparatus, a torquemeter, a nitrogen gas introducing tube, a thermometer, and a reflux condenser, a gas in the reactor was replaced by a nitrogen gas, and then, under a nitrogen gas flow, with stirring, temperature was increased from room temperature to 150° C. over 15 minutes, and the mixture was refluxed at 150° C. for 3 hours. Then, while by-product acetic acid and unreacted acetic anhydride were distilled off, temperature was increased from 150° C. to 300° C. over 2 hours and 50 minutes and maintained at 300° C. for 1 hour, and then, contents were removed from the reactor and cooled to room temperature. Solid phase polymerization was performed by grinding an obtained solid to a particle diameter of about 0.1 to 1 mm by a grinder, and, under a nitrogen gas atmosphere, increasing temperature from room temperature to 223° C. over 6 hours and maintaining temperature at 223° C. for 3 hours. After the solid phase polymerization, a product was cooled to obtain a powdery liquid crystal polyester. The flow start temperature of this liquid crystal polyester was 270° C.

<Preparation of Liquid Composition>

2200 g of the liquid crystal polyester was added to 7800 g of N,N-dimethylacetamide, and the mixture was heated at 100° C. for 2 hours to obtain a liquid composition as a solution.

<Production of Resin-Impregnated Sheet>

A glass cloth (Arisawa Mfg. Co., Ltd., thickness: 96 μm, IPC name: 2116) was used as a fiber sheet, the glass cloth was impregnated with the liquid composition, then, the solvent was evaporated at 160° C. using a hot air dryer, then, heat treatment was performed under a nitrogen gas atmosphere at 290° C. for 3 hours using the hot air dryer to obtain a resin-impregnated sheet. The content of the liquid crystal polyester in this resin-impregnated sheet was 47% by mass. In addition, the thickness of this resin-impregnated sheet was 133 μm on average, and variations in thickness were 3%.

<Production of Resin-Impregnated Sheet with Conductive Layers>

Copper foil (“3EC-VLP” from Mitsui Mining & Smelting Co., Ltd., 18 μm) was disposed on both sides of the resin-impregnated sheet, and they were pressed at 5 MPa at 340° C. for 30 minutes, using a high-temperature vacuum press (“VH1-1765” from KITAGAWA SEIKI CO., LTD), to obtain a resin-impregnated sheet with conductive layers. The thickness of a resin-impregnated sheet layer in this resin-impregnated sheet with conductive layers was 109 μm on average, and variations in thickness were 3%. For this resin-impregnated sheet with conductive layers, a relative dielectric constant, a dielectric loss tangent, and the coefficient of linear expansion were measured, and solder heat resistance was evaluated. Results are shown in Table 1.

### Comparative Example 2

An operation similar to that of Comparative Example 1 was performed, except that a glass cloth (Arisawa Mfg. Co., Ltd., thickness: 45 μm, IPC name: 1078) was used as a fiber sheet, to obtain a resin-impregnated sheet. The content of the liquid crystal polyester in this resin-impregnated sheet was 50% by mass. In addition, the thickness of this resin-impregnated sheet was 68 μm on average, and variations in thickness were 3%.

Then, a resin-impregnated sheet with conductive layers was obtained by an operation similar to that of Example 1. The thickness of a resin-impregnated sheet layer in this resin-impregnated sheet with conductive layers was 57 μm on average, and variations in thickness were 3%. For this resin-impregnated sheet with conductive layers, a relative dielectric constant, a dielectric loss tangent, and the coefficient of linear expansion were measured, and solder heat resistance was evaluated. Results are shown in Table 1.

TABLE 1

| | | Example | Example | Comparative | Comparative |
|---|---|---|---|---|---|
| Example | | 1 | 2 | Examples 1 | Example 2 |
| Thickness of | | 105 | 56 | 109 | 57 |
| resin-impregnated | | | | | |
| sheet layer (μm) | | | | | |
| Relative dielectric | | 4.4 | 3.9 | 4.6 | 4.3 |
| constant | | | | | |
| Dielectric loss | | 0.0028 | 0.0025 | 0.0065 | 0.0065 |
| tangent | | | | | |
| Coefficient | X | 11 | 11 | 12 | 11 |
| of linear | direction | | | | |
| expansion | Y | 12 | 10 | 12 | 11 |
| (ppm/° C.) | direction | | | | |

| | | | | |
|---|---|---|---|---|
| Solder heat | ◯ | ◯ | ◯ | ◯ |
| resistance | | | | |

What is claimed is:

1. A resin-impregnated sheet prepared by a fiber sheet being impregnated with a liquid crystal polyester which has a repeating unit represented by formula (1), a repeating unit represented by formula (2), and a repeating unit represented by formula (3) and in which a content of a repeating unit comprising a 2,6-naphthylene group is 40 mole % or more with respect to a total of all repeating units,
—O—Ar¹—CO— (1)
—CO—Ar²—CO— (2)
—O—Ar³—O— (3)
wherein Ar¹ represents a 2,6-naphthylene group, a 1,4-phenylene group, or a 4,4′-biphenylylene group; Ar² and Ar³ each independently represent a 2,6-naphthylene group, a 1,4-phenylene group, a 1,3-phenylene group, or a 4,4′-biphenylylene group; and hydrogen atoms present in the group represented by Ar¹, Ar², or Ar³ may each independently be replaced by a halogen atom, an alkyl group, or an aryl group.

2. The resin-impregnated sheet according to claim 1, prepared by the fiber sheet being melt impregnated with the liquid crystal polyester.

3. The resin-impregnated sheet according to claim 1, prepared by a sheet composed of the liquid crystal polyester and the fiber sheet being pressed.

4. The resin-impregnated sheet according to claim 1, wherein a fiber constituting the fiber sheet is a glass fiber.

5. A resin-impregnated sheet with a conductive layer, comprising the resin-impregnated sheet according to claim 1, and a conductive layer formed on at least one surface of the resin-impregnated sheet.
